(19) United States
(12) Patent Application Publication
(10) Pub. No.: US 2013/0190053 A1
(43) Pub. Date: Jul. 25, 2013

(54) Cell Phone Purse

(71) Applicant: Larriann Kelly, Mesquite, TX (US)

(72) Inventor: Larriann Kelly, Mesquite, TX (US)

(21) Appl. No.: 13/356,446

(22) Filed: Jan. 23, 2012

(51) Int. Cl. H04W 88/02

(52) U.S. Cl. 455/566; 455/575.1

(57) ABSTRACT

A phone and purse device to house a wireless phone and personal items may include a phone housing to house the wireless phone, a purse housing being connected to the phone housing to house personal items, and an elongated strap being connected to the phone housing for carrying the phone and purse device. The phone housing may include a bottom wall which may be detachably connected to the phone housing to allow access to a cavity defined by the phone housing to cooperate with the wireless phone.

### FIELD OF THE INVENTION

The present invention relates to storage devices for personal items and more particularly to a combination of a phone housing to store a wireless phone and to make it accessible for usage.

### BACKGROUND

Cell phones which include smart phones, PDAs, tablets and other devices which may be used for wireless connections are an important part of communication in today's society. Storage of these items and other personal items remains a problem. These devices need to be securely stowed because dropping one of these devices may prematurely end the life of these phones. Furthermore, it is desirable in order to access these phones quickly because some callers are inpatient and will terminate the call just after a few rings. Consequently, it is desirable to stow these devices securely and where they can be easily reached.

Additionally, these wireless phones may be targets for thieves to steal them. Most holders for the wireless phones may allow for easy access to the wireless phone.

### SUMMARY

A phone and purse device to house a wireless phone and personal items may include a phone housing to house the wireless phone, a purse housing being connected to the phone housing to house personal items, and an elongated strap being connected to the phone housing for carrying the phone and purse device. The phone housing may include a bottom wall which may be detachably connected to the phone housing to allow access to a cavity defined by the phone housing to cooperate with the wireless phone usage.

The phone housing may be formed from flexible material.

The purse housing may be formed from flexible material.

The phone housing may include a front wall having an aperture to cooperate with the display of the wireless device.

### BRIEF DESCRIPTION OF THE DRAWINGS

The invention may be understood by reference to the following description taken in conjunction with the accompanying drawings, in which, like reference numerals identify like elements, and in which:

FIG. 1 illustrates a front view of the phone and purse device of the present invention;

FIG. 2 illustrates a side view of the phone and purse device of the present invention;

FIG. 3 illustrates a back view of the phone and purse device of the present invention;

FIG. 4 illustrates a bottom view of the phone and purse device of the present invention;

FIG. 5 illustrates a top view of the phone numbers device of the present invention;

FIG. 6 illustrates a front view of another embodiment of the present invention.

### DETAILED DESCRIPTION

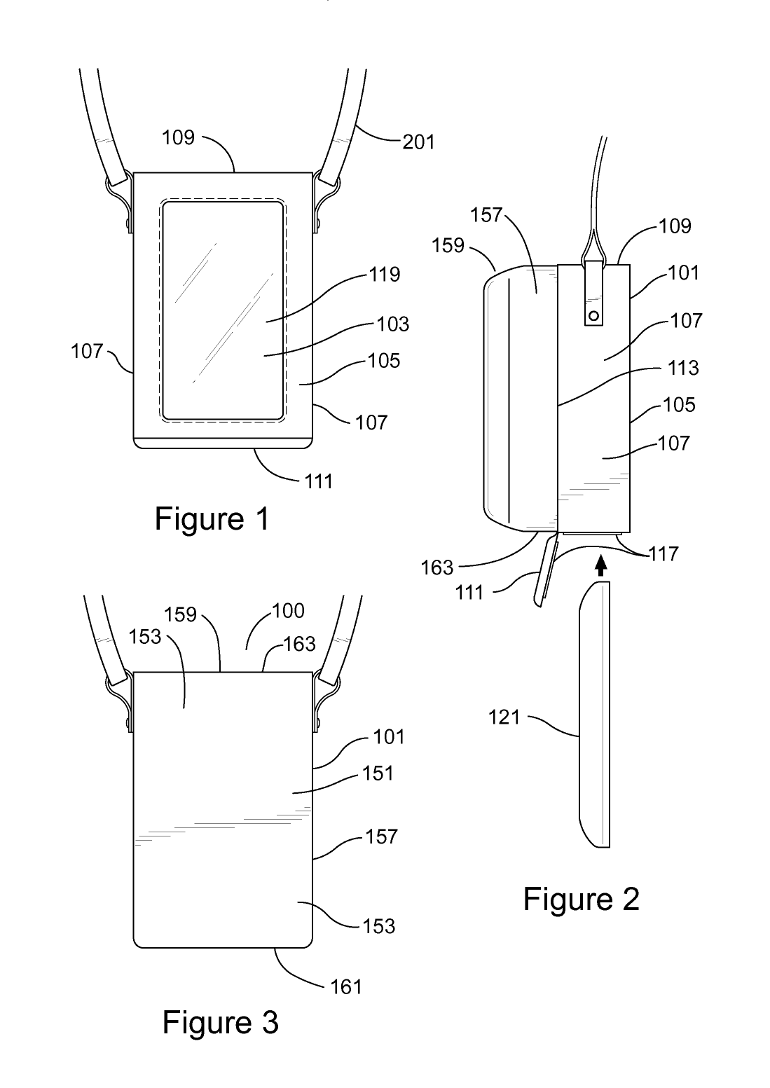

FIG. 1 illustrates a front view of the phone and purse device 100 of the present invention and the phone and purse device 100 may include a phone housing 101 and a purse housing 151. The phone housing 101 maybe formed from flexible but substantially rigid material such as leather, plastic, fabric, or other appropriate material and may be substantially hollow defining a housing cavity 103 which may cooperate with a wireless phone 121 such as a cell phone, PDA, tablet or other appropriate devices. The phone housing 101 may be substantially rectangular or any other appropriate shape and may include a phone housing front wall 105 which may be connected to an opposing phone housing side walls 107, which may be connected to a phone housing top wall 109 and which may be connected to a phone housing bottom wall 111. The phone housing side wall 107 may be connected to the phone housing top wall 109, the phone housing front wall 105, and the phone housing back wall 113. The phone housing back wall 113 may be connected to the opposing phone housing side walls 107, and the phone housing top wall 109, and the phone housing back wall 113 may be detachably connected to the phone housing bottom wall 111 by a fastening device 117 which may be Velcro (hooks and loops) buttons, snaps or other fastening devices.

The phone housing top wall 109 may be connected to the phone housing side wall 107, the phone housing back wall 111, and the phone housing front wall 105. The phone housing top wall 109 may be connected to a strap 201 which may be of sufficient length in order to extend around the head or shoulder of the user and may be formed from leather, metal, chain or other appropriate material.

The phone housing front wall 105 may include a phone housing display aperture 119 which may be rectangular, oval, circular or other shape in order to cooperate with a display of a wireless device 121 as illustrated in FIG. 2.

The phone housing bottom wall 111 may include phone housing slits 123 to cooperate with the microphone of the wireless device 121 and may include phone housing antenna aperture 125 to cooperate with the antenna of the wireless device 121.

FIG. 2 illustrates that the phone housing 101 may be substantially rectangular or any other appropriate shape and may include a phone housing front wall 105 which may be connected to an opposing phone housing side walls 107, which may be connected to a phone housing top wall 109 and which may be connected to a phone housing bottom wall 111. The phone housing side wall 107 may be connected to the phone housing top wall 109, the phone housing front wall 105, and the phone housing back wall 113. The phone housing back wall 113 may be connected to the opposing phone housing side walls 107, and the phone housing top wall 109, and the phone housing back wall 113 may be detachably connected to the phone housing bottom wall 111 by a fastening device 117 which may be Velcro (hooks and loops) buttons, snaps or other fastening devices.

FIG. 2 illustrates that the purse housing 151 may be substantially rectangular or any other appropriate shape and may include a purse housing front wall 153 which may be connected to an opposing purse housing side walls 157, which may be connected to a purse housing top wall 159 and which may be connected to a purse housing bottom wall 161. The purse housing side wall 157 may be connected to the purse housing top wall 159, the purse housing front wall 153, and the purse housing back wall 163. The purse housing back wall 163 may be connected to the opposing purse housing side walls 157, and the purse housing top wall 159, and the purse housing back wall 163 may be connected to the purse housing bottom wall.

The purse housing top wall 159 may include a reclosable slit 165 to access the purse housing cavity 153

FIG. 3 illustrates a back view of the phone and purse device 100 of the present invention, and the phone and purse device 100 may include a purse housing 101 and a purse housing 151. The purse housing 151 maybe formed from flexible but substantially rigid material such as leather, plastic, fabric, or other appropriate material and may be substantially hollow defining a housing cavity 153 which may cooperate with items such as keys, change and other material commonly found in the purse. Alternatively, the purse housing 151 may be rigid and maybe formed from rigid material such as metal, hard plastic or other appropriate material. The purse housing 151 may be substantially rectangular or any other appropriate shape and may include a purse housing front wall 153 which may be connected to an opposing purse housing side walls 157, which may be connected to a purse housing top wall 159 and which may be connected to a purse housing bottom wall 161. The purse housing side wall 157 may be connected to the purse housing top wall 159, the purse housing front wall 153, and the purse housing back wall 163. The purse housing back wall 163 may be connected to the opposing purse housing side walls 157, and the purse housing top wall 159, and the purse housing back wall 163 may be connected to the purse housing bottom wall.

The purse housing top wall 159 may include a reclosable slit 165 to access the purse housing cavity 153.

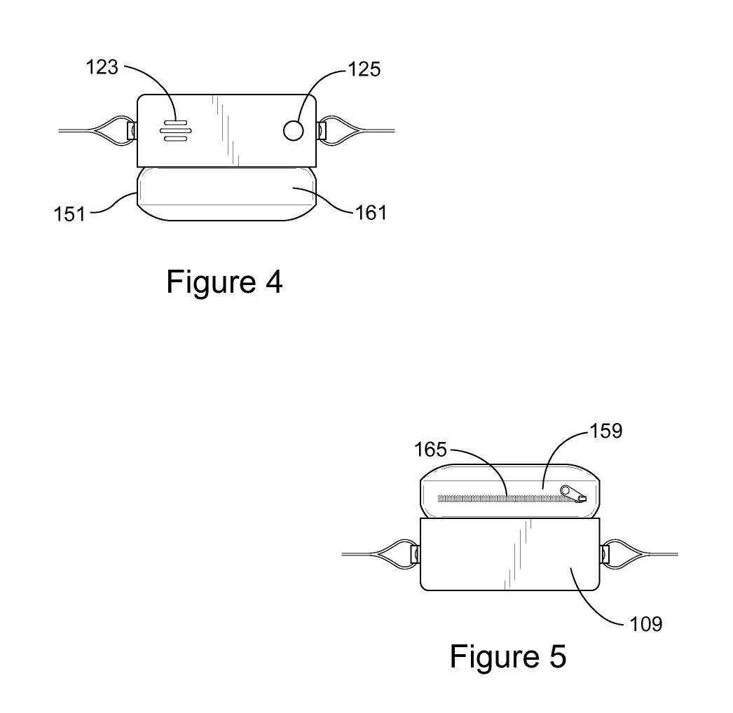

FIG. 4 illustrates a bottom view and illustrates the phone housing bottom wall 111, the purse housing bottom wall 161, the phone housing slits 123 and the phone housing antenna aperture 125.

FIG. 5 illustrates a top view and illustrates the phone housing top wall 109, the purse housing top wall 159, and the reclosable slit 165.

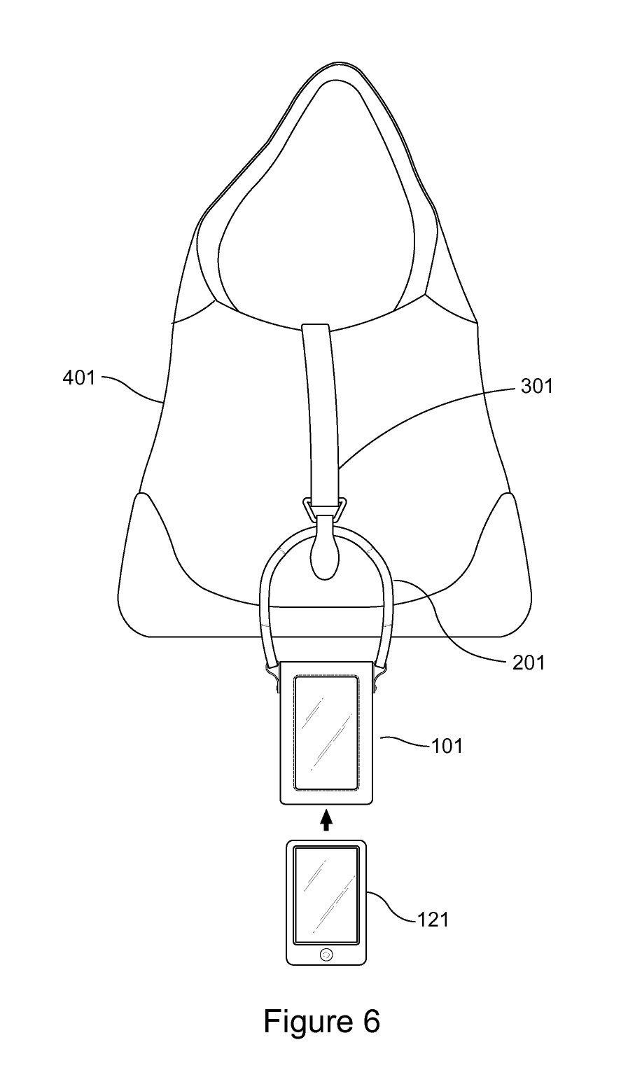

FIG. 6 illustrates another embodiment of the present invention and illustrates a wireless device 121 being inserted into the phone housing 101 which may be detachably connected to a purse 401 by a first strap 201 which may be connected to the phone housing 101 which may cooperate with the wireless device 121 by a first strap 201 which may be connected to a second strap 301 which may be connected to the purse 401.

While the invention is susceptible to various modifications and alternative forms, specific embodiments thereof have been shown by way of example in the drawings and are herein described in detail. It should be understood, however, that the description herein of specific embodiments is not intended to limit the invention to the particular forms disclosed.

1) A phone and purse device to house a wireless phone and personal items, comprising:
a phone housing to house the wireless phone;
a purse housing being connected to the phone housing to house personal items;
an elongated strap being connected to the phone housing for carrying the phone and purse device;
wherein the phone housing includes a bottom wall which may be detachably connected to the phone housing to allow access to a cavity defined by the phone housing to cooperate with the wireless phone.

2) A phone and purse device to house a wireless phone and personal items as in claim 1, wherein the phone housing is formed from flexible material.

3) A phone and purse device to house a wireless phone and personal items as in claim 1, wherein the purse housing is formed from flexible material.

4) A phone and purse device to house a wireless phone and personal items as in claim 1, wherein the phone housing includes a front wall having a aperture to cooperate with the display of the wireless device.
